(19) United States
(12) Patent Application Publication
(10) Pub. No.: US 2009/0252481 A1
(43) Pub. Date: Oct. 8, 2009

(54) METHODS, APPARATUS, SYSTEM AND COMPUTER PROGRAM PRODUCT FOR AUDIO INPUT AT VIDEO RECORDING

(75) Inventor: Simon Ekstrand, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/103,189

(22) Filed: Apr. 15, 2008

Related U.S. Application Data
(60) Provisional application No. 61/042,874, filed on Apr. 7, 2008.

(51) Int. Cl. H04N 5/91

(52) U.S. Cl. 386/96; 386/E05.001

(57) ABSTRACT

Methods for audio input at video recording comprising capturing a video sequence by a first apparatus; receiving by the first apparatus a audio sequence from a second apparatus captured simultaneously by the second apparatus; and compiling the video sequence and the received audio sequence, and comprising capturing an audio sequence by a second apparatus; transmitting the audio sequence from the second apparatus to a first apparatus having simultaneously captured a video sequence such that the video sequence and the audio sequence are compilable in the first apparatus, respectively, are disclosed. Apparatuses, system and computer programs for performing the methods are also disclosed.

### CROSS-REFERENCE TO RELATED APPLICATION

This application claims the benefit of U.S. Provisional Patent Application Ser. No. 61/042,874, filed Apr. 7, 2008, the entire disclosure of which is hereby incorporated by reference.

### FIELD OF INVENTION

The present invention relates to methods for audio input at video recording, and apparatuses, system and computer program for performing the method.

### BACKGROUND OF INVENTION

Portable apparatuses, such as personal digital assistants, mobile telephones or digital cameras, become better video recording properties and play a role for capturing video sequences, which are suitable of for example publication on the Internet or as a news feature in broadcasted television. Although video quality has become better, a problem is often that audio quality in some environments where the desired audio is obscured by other surrounding noise.

### SUMMARY

Therefore, the inventor has found an approach that is both field applicable and efficient also for small apparatuses. The basic understanding behind the invention is that this is possible since audio streaming is possible between apparatuses having wireless communication capabilities. The inventor realized that the increased freedom of capturing the video content by a camera of one first apparatus, and possibly also audio content by a microphone of that apparatus, and also capturing audio input by a microphone of at lease a second apparatus, which streams the captured audio input to the first apparatus, which then is able to compile an aggregate video and audio content based at least on the captured video content and the audio content captured by the second apparatus.

According to a first aspect of the present invention, there is provided a method for audio input at video recording comprising capturing a video sequence by a first apparatus; receiving by the first apparatus a audio sequence from a second apparatus captured simultaneously by the second apparatus; and compiling the video sequence and the received audio sequence.

The method may further comprise sending a request from the first apparatus to the second apparatus to capture audio sequence.

The receiving of the audio sequence may comprise receiving an audio stream of the audio sequence. The receiving of the audio sequence may comprise receiving the audio sequence as a file.

The audio sequence may comprise a time stamp for enabling compiling of the video sequence and the audio sequence.

The method may further comprise receiving by the first apparatus a third audio sequence from a third apparatus captured simultaneously by the third apparatus; and compiling also the third audio sequence with the video sequence.

The compiling may comprise mixing the audio sequences such that each audio sequence is given a mutually relative signal level in an aggregate audio sequence.

The method may further comprise capturing by the first apparatus simultaneously a first audio; and compiling also the first audio sequence with the video sequence.

The compiling may comprise mixing the audio sequences such that each audio sequence is given a mutually relative signal level in an aggregate audio sequence.

The method may further comprise establishing an audio channel between the second apparatus and the first apparatus.

The method may further comprise receiving by the first apparatus a video sequence from the second apparatus captured at least partly simultaneously by the second apparatus; and compiling also the video sequence and the received video sequence.

According to a further aspect, there is provided a method for audio input at video recording comprising capturing an audio sequence by a second apparatus; transmitting the audio sequence from the second apparatus to a first apparatus having simultaneously captured a video sequence such that the video sequence and the audio sequence are compilable in the first apparatus.

The method may further comprise receiving a request from the first apparatus to the second apparatus to capture audio sequence.

The transmitting of the audio sequence may comprise transmitting an audio stream of the audio sequence. The transmitting of the audio sequence may comprise transmitting the audio sequence as a file.

The method may further comprise assigning time stamps in the audio sequence comprises for enabling compiling of the video sequence and the audio sequence.

The method may further comprise establishing an audio channel between the second apparatus and the first apparatus.

The method may further comprise capturing a video sequence by a second apparatus; transmitting the video sequence from the second apparatus to a first apparatus having at least partly simultaneously captured a video sequence such that the video sequences are compilable in the first apparatus.

According to a further aspect, there is provided an apparatus comprising

a camera arranged to capture a video sequence; a receiver; a processor arranged to compile the video sequence captured by the camera with an audio sequence received from a second apparatus by the receiver and captured simultaneously as the video sequence by the second apparatus.

The receiver may be arranged to receive a video sequence at least partly simultaneously captured by a camera of the second apparatus, wherein the processor is further arranged to compile the video sequences.

According to a further aspect, there is provided a system comprising a first apparatus; and a second apparatus, wherein the second apparatus comprises a microphone arranged to capture an audio sequence; a transmitter; and a processor arranged to transmit the audio sequence to the first apparatus by the transmitter, and the first apparatus comprises a camera arranged to capture a video sequence; a receiver; and a processor arranged to compile the video sequence captured by the camera with the audio sequence received from the second apparatus by the receiver and captured simultaneously as the video sequence by the second apparatus.

The system may comprise at least one network node, wherein the audio sequence transmitted from the second apparatus to the first apparatus is transmitted via the at least one network node.

The second apparatus may further comprise a camera arranged to capture a video sequence, the processor of the second apparatus may be further arranged to transmit the video sequence to the first apparatus by the transmitter, the receiver of the first apparatus may be arranged to receive the video sequence at least partly simultaneously captured by the camera of the second apparatus, and the processor of the first apparatus may be further arranged to compile the video sequences.

According to a further aspect, there is provided a computer readable medium comprising program code comprising instructions which when executed by a processor is arranged to cause the processor to perform capturing a video sequence by a first apparatus; receiving by the first apparatus a audio sequence from a second apparatus captured simultaneously by the second apparatus; and compiling the video sequence and the received audio sequence.

The program code may further comprise instructions which when executed by a processor is arranged to cause the processor to perform receiving by the first apparatus a third audio sequence from a third apparatus captured simultaneously by the third apparatus; and compiling also the third audio sequence with the video sequence.

The program code instructions for compiling may further be arranged to cause the processor to perform mixing the audio sequences such that each audio sequence is given a mutually relative signal level in an aggregate audio sequence.

The program code may further comprise instructions which when executed by a processor is arranged to cause the processor to perform capturing by the first apparatus simultaneously a first audio; and compiling also the first audio sequence with the video sequence.

The program code instructions for compiling may further be arranged to cause the processor to perform mixing the audio sequences such that each audio sequence is given a mutually relative signal level in an aggregate audio sequence.

The program code may further comprise instructions which when executed by a processor is arranged to cause the processor to perform sending a request from the first apparatus to the second apparatus to capture audio sequence; and establishing an audio channel between the second apparatus and the first apparatus.

The program code may further comprise instructions which when executed by a processor is arranged to cause the processor to perform receiving by the first apparatus a video sequence from a second apparatus captured at least partly simultaneously by the second apparatus; and compiling the video sequences.

### BRIEF DESCRIPTION OF DRAWINGS

FIG. 1 illustrates methods performed in apparatuses of a system according to embodiments of the present invention.

FIG. 2 is a block diagram illustrating apparatuses and system according to embodiments of the present invention.

FIG. 3 schematically illustrates a computer readable medium according to an embodiment of the present invention.

### DETAILED DESCRIPTION OF EMBODIMENTS

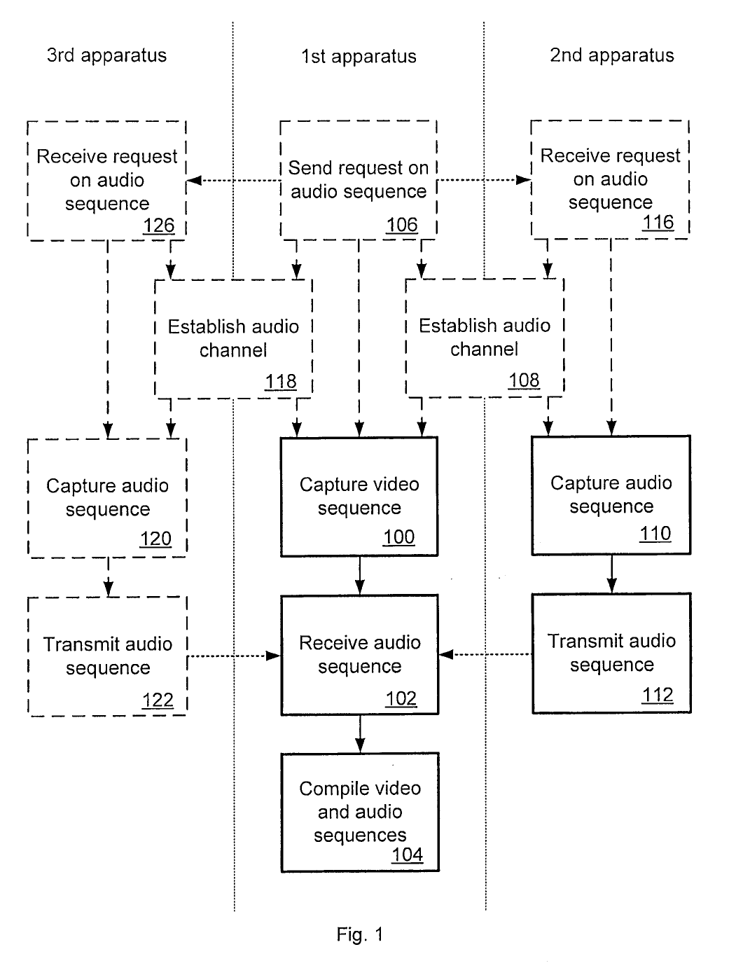

FIG. 1 illustrates methods performed in apparatuses of a system according to embodiments of the present invention. Flow charts for a first and a second apparatus, as well as for an optional third apparatus are shown, where optional actions are drawn with dashed lines and data transfer between the processes are drawn as horizontal dotted arrows. The actions for the optional third apparatus should be construed to be representative for a third, fourth, and further optional apparatus interacting with the first apparatus. Any of the second and the further apparatuses can also provide a second or further video sequence to the first apparatus, besides the approach of providing a second or further audio sequence demonstrated in FIG. 1. The second or further audio and/or video sequences can also be provided with meta data, such as positioning, orientation, and/or encoding data. The positioning data can be used for providing three-dimensional audio. The positioning data can also be used for compensating for delay of audio and/or audio volume to provide a more accurate aggregate audio signal. It can also be possible to, the other way around, determine position from delay of audio and/or audio volume.

According to one embodiment, the first apparatus captures a video sequence in a video capturing step 100. Simultaneously, the second apparatus captures an audio sequence in an audio capturing step 110. The second apparatus transmits the captured audio sequence to the first apparatus in an audio transmission step 112 such that the first apparatus can receive the audio sequence in an audio reception step 102. The audio sequence transmission can be based on streaming of the audio content or be based on a file transfer of the audio sequence. Then, the video and audio sequences are compiled in a compilation step 104 such that the video and audio sequences are fairly synchronized. Synchronization can be performed based on time stamps assigned to the sequences.

According to another embodiment, the first apparatus sends a request for an audio sequence to be captured to the second apparatus in an audio sequence request step 106. The request is received by the second apparatus in a request reception step 116. Optionally, an audio channel is established between the first and the second apparatus in an audio channel establishment step 108, such that the audio sequence can be streamed from the second apparatus to the first apparatus. The process then continues similar to what has been described for the embodiment above.

According to further another embodiment, the first apparatus captures a video sequence in the video capturing step 100. Simultaneously, the second apparatus captures an audio sequence in the audio capturing step 110 and the third apparatus captures an audio sequence in an audio capturing step 120. The second apparatus transmits the captured audio sequence to the first apparatus in the audio transmission step 112 and the third apparatus transmits the captured audio sequence to the first apparatus in the audio transmission step 122 such that the first apparatus can receive the audio sequences in the audio reception step 102. The audio sequence transmissions can be based on streaming of the audio content or be based on a file transfer of the audio sequence. Then, the video and audio sequences are compiled in a compilation step 104 such that the video and audio sequences are fairly synchronized. Synchronization can be performed based on time stamps assigned to the sequences. The audio sequences can be mixed in the compilation step 104 and each be given a relative level with relation to each other to provide a desired aggregate audio track to the video.

According to further another embodiment, the first apparatus also sends a request for an audio sequence to be captured to the third apparatus in the audio sequence request step 106. The request is received by the third apparatus in a request reception step 126. Optionally, an audio channel is established between the first and the third apparatus in an audio channel establishment step 118, such that the audio sequence can be streamed from the third apparatus to the first apparatus. The process then continues similar to what has been described for the embodiment above.

In any of the embodiments above, an audio sequence can also be captured by the first apparatus, which can be mixed in the compilation step 104 and each be given a relative level with relation to the other audio sequence(s) to provide a desired aggregate audio track to the video. Any of the audio sequences can be in mono, stereo, or other multi-channel/surround configuration, and be compiled accordingly.

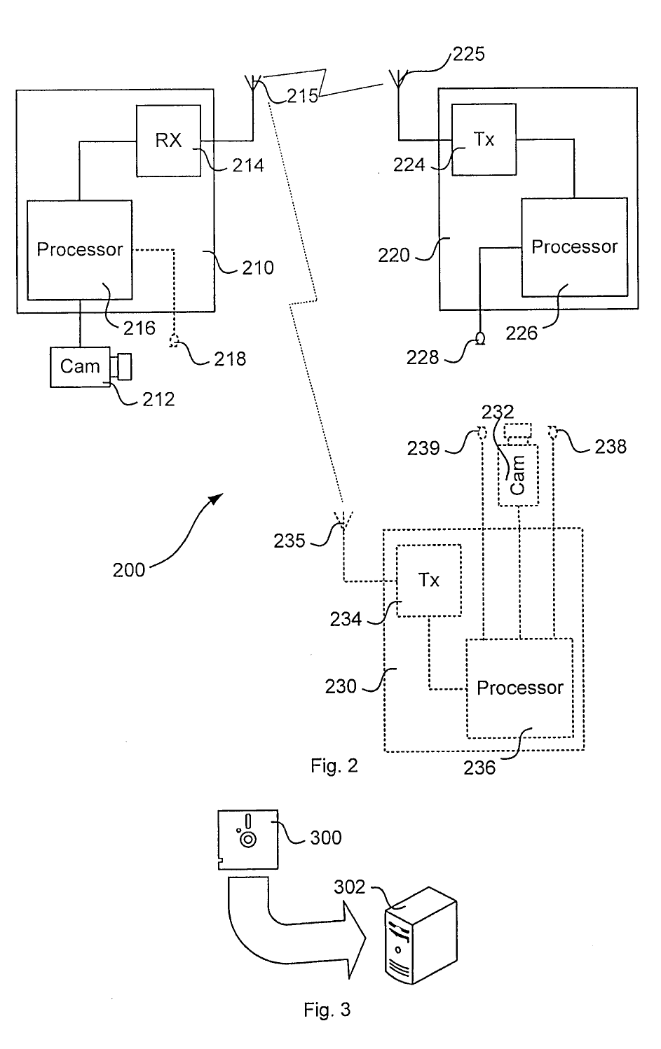

FIG. 2 is a block diagram illustrating apparatuses 210, 220, 230 of a system 200 according to embodiments of the present invention. The optional third apparatus 230 should be construed to be representative for a third, fourth, and further optional apparatus interacting with the first apparatus 210. Any of the second and the further apparatuses 220, 230 can also provide a second or further video sequence to the first apparatus, besides the approach of providing a second or further audio sequence demonstrated in FIG. 2. The second or further audio and/or video sequences can also be provided with meta data, such as positioning, orientation, and/or encoding data.

According to one embodiment, the first apparatus 210 comprises a camera 212 arranged to capture a video sequence, a receiver 214, e.g. connected to an antenna 215 to enable reception of signals comprising an audio sequence from any of the other apparatuses 220, 230, and a processor 216 arranged to compile the video sequence with the received audio sequence. The video sequence and the audio sequence are preferably captured simultaneously and being synchronized when compiled. Synchronization can be achieved by using time stamps in the sequences, or simply relying on a common starting point in time. More sophisticated synchronization techniques based on image and audio processing can also be employed. The second apparatus 220 comprises a transmitter 224, e.g. connected to an antenna 225 to enable transmission of signals comprising an audio sequence to the first apparatus 210, a processor 226 arranged to control transmission of the audio sequence and capturing of the audio sequence by a microphone 228. The first apparatus 210 can also comprise a microphone 218 for capturing an audio sequence, which can be mixed together with the received audio sequence from the second apparatus 220. The receiver 215 and the transmitter 225 can be transceivers for establishing a two-way communication between the apparatuses, e.g. for control of audio capturing. The first apparatus 210 can for example send a request to the second apparatus 220 on starting to capture the audio sequence. The request procedure can also comprise a negotiation on audio quality, encoding, etc. The first apparatus 210 can for example be a mobile phone, a digital camera, or a personal digital assistant having communication and video capturing features, while the second apparatus 220 can be, in addition to the examples given for the first apparatus 210, a headset or portable handsfree device having communication features to be able to communicate with the first apparatus 210.

A use case can be a video clip to be produced by means of a mobile phone 210 on a crowded place with a significant level of ambient sounds. The video capturing capabilities of the mobile phone 210 is to be used, but audio pick-up by the microphone 218 of the mobile phone 210 would make it hard or impossible to hear comments from a person being a “reporter” on the video clip if there is some distance between the mobile phone 210 and the reporter, e.g. if the environment is to be on the video clip as well. Thus, the reporter uses his mobile phone or portable handsfree device 220 for audio capturing and the captured audio sequence is transmitted to the mobile phone 210 where it is compiled with the video sequence to produce a suitable video clip. Audio captured with the microphone 218 of the mobile phone 210 can be mixed together with the audio sequence from the reporter's apparatus 220 such that the level of the audio sequence captured by microphone 218 is much lower than the level of audio sequence from the reporter's apparatus 220 to give a feeling of the ambient situation although not obscuring the comments of the reporter.

According to a further embodiment, also a third or further apparatus 230 comprising a transmitter 234, e.g. connected to an antenna 235 to enable transmission of signals comprising an audio sequence to the first apparatus 210, a processor 236 arranged to control transmission of the audio sequence and capturing of the audio sequence by a microphone 238. The third apparatus 230 can optionally comprise a second microphone 239 for enabling e.g. stereophonic audio. The third apparatus can also optionally comprise a camera 232 for video capturing, wherein a captured video sequence by the camera 232, similar to the captured audio sequence, can be transmitted to the first apparatus 210 to be compiled to the desired video clip. The properties of the third or further apparatus 230 can thus be similar to that of the second apparatus 220, which of course also can have capabilities of stereophonic audio capturing and video capturing.

A use case can be a video clip to be produced by means of a mobile phone 210 on a crowded place with a significant level of ambient sounds. The video capturing capabilities of the mobile phone 210 is to be used, but audio pick-up by the microphone 218 of the mobile phone 210 would make it hard or impossible to hear comments from a person being a “interviewee” on the video clip if there is some distance between the mobile phone 210 and the interviewee, e.g. if the environment is to be on the video clip as well. Thus, the interviewee uses his mobile phone or portable handsfree device 220 for audio capturing and the captured audio sequence is transmitted to the mobile phone 210 where it is compiled with the video sequence to produce a suitable video clip. At the same time, audio pick-up by the microphone 218 of the mobile phone 210 or the microphone 228 of the interviewee's apparatus 220 would make it hard or impossible to hear comments from a person being a “reporter” interviewing the interviewee on the video clip if there is some distance between the apparatuses 210, 220 and the reporter. Thus, the reporter uses e.g. his mobile phone 230 for audio capturing and the captured audio sequence is transmitted to the mobile phone 210 where it is compiled with the video sequence and the other audio sequence(s) to produce a suitable video clip. The reporter can also use his mobile phone to capture close-ups of the interviewee during some moments of the interview, wherein the camera 232 of the reporter's mobile phone 230 is used, and these video sequences are sent to the first apparatus 210 to be compiled with the main video clip. Compilation can be aided by time stamps of the sequences. Audio captured with the microphone 218 of the mobile phone 210 can be mixed together with the audio sequence from the reporter's apparatus 230 such that the level of the audio sequence captured by microphone 218 is much lower than the level of audio sequence from the reporter's apparatus 230 to give a feeling of the ambient situation although not obscuring the comments of the reporter. Similarly, the audio sequence from the interviewee's apparatus 220 is mixed such that it is in level with the audio sequence of the reporter. It is to be noted that in the resulting compiled production, the several audio sequences can be present at the same time, while the video sequences preferably are present one at a time. The compilation can be according to the user's preferences, and can optionally be re-mixed and re-cut afterwards the capturing. This way, a “semi-professional” news feature can be produced with inexpensive equipment that can be anyone's property.

In FIG. 1, transmissions between the apparatuses 210, 220, 230 are illustrated to be directly between the apparatuses. However, the transmissions can be via one or more network nodes, e.g. via a telecommunication network, a local area network, a scatternet, the Internet, or a combination of these.

Upon performing the method, operation according to any of the examples given with reference to FIG. 1 or 2 can be performed. The method according to the present invention is suitable for implementation with aid of processing means, such as computers and/or processors. Therefore, there is provided computer programs comprising instructions arranged to cause the processing means, processor, or computer to perform the steps of the methods according to any of the embodiments described with reference to FIG. 1, respectively. The computer program preferably comprises program code which is stored on a computer readable medium 300, as illustrated in FIG. 3, which can be loaded and executed by a processing means, processor, or computer 302 to cause it to perform the method according to the present invention, preferably as any of the embodiments described with reference to FIG. 1. The computer 302 and computer program product 300 can be arranged to execute the program code sequentially where actions of the any of the methods are performed stepwise, but mostly be arranged to execute the program code on a real-time basis where actions of any of the methods are performed upon need and availability of data. The processing means, processor, or computer 302 is preferably what normally is referred to as an embedded system. Thus, the depicted computer readable medium 300 and computer 302 in FIG. 3 should be construed to be for illustrative purposes only to provide understanding of the principle, and not to be construed as any direct illustration of the elements. The computer 302 can, as demonstrated above, be part of a mobile phone, a digital camera, a personal digital assistant, a wireless headset or portable handsfree device, or other apparatus having the features described with reference to FIG. 2. The computer program can be a native program, an applet, or separate application for the apparatus.

1. A method for audio input at video recording comprising
capturing a video sequence by a first apparatus;
receiving by the first apparatus a audio sequence from a second apparatus captured simultaneously by the second apparatus; and
compiling the video sequence and the received audio sequence.

2. The method according to claim 1, further comprising
sending a request from the first apparatus to the second apparatus to capture audio sequence.

3. The method according to claim 1, wherein the receiving of the audio sequence comprises receiving an audio stream of the audio sequence.

4. The method according to claim 1, wherein the receiving of the audio sequence comprises receiving the audio sequence as a file.

5. The method according to claim 1, wherein the audio sequence comprises a time stamp for enabling compiling of the video sequence and the audio sequence.

6. The method according to claim 1, further comprising
receiving by the first apparatus a third audio sequence from a third apparatus captured simultaneously by the third apparatus; and
compiling also the third audio sequence with the video sequence.

7. The method according to claim 6, wherein the compiling comprises mixing the audio sequences such that each audio sequence is given a mutually relative signal level in an aggregate audio sequence.

8. The method according to claim 1, further comprising
capturing by the first apparatus simultaneously a first audio; and
compiling also the first audio sequence with the video sequence.

9. The method according to claim 8, wherein the compiling comprises mixing the audio sequences such that each audio sequence is given a mutually relative signal level in an aggregate audio sequence.

10. The method according to claim 1, further comprising
establishing an audio channel between the second apparatus and the first apparatus.

11. The method according to claim 1, further comprising
receiving by the first apparatus a video sequence from the second apparatus captured at least partly simultaneously by the second apparatus; and
compiling also the video sequence and the received video sequence.

12. A method for audio input at video recording comprising
capturing an audio sequence by a second apparatus;
transmitting the audio sequence from the second apparatus to a first apparatus having simultaneously captured a video sequence such that the video sequence and the audio sequence are compilable in the first apparatus.

13. The method according to claim 12, further comprising
receiving a request from the first apparatus to the second apparatus to capture audio sequence.

14. The method according to claim 12, wherein the transmitting of the audio sequence comprises transmitting an audio stream of the audio sequence.

15. The method according to claim 12, wherein the transmitting of the audio sequence comprises transmitting the audio sequence as a file.

16. The method according to claim 12, further comprising assigning time stamps in the audio sequence comprises for enabling compiling of the video sequence and the audio sequence.

17. The method according to claim 12, further comprising
establishing an audio channel between the second apparatus and the first apparatus.

18. The method according to claim 12, further comprising
capturing a video sequence by a second apparatus;
transmitting the video sequence from the second apparatus to a first apparatus having at least partly simultaneously captured a video sequence such that the video sequences are compilable in the first apparatus.

19. An apparatus comprising
a camera arranged to capture a video sequence;
a receiver;
a processor arranged to compile the video sequence captured by the camera with an audio sequence received from a second apparatus by the receiver and captured simultaneously as the video sequence by the second apparatus.

20. The apparatus according to claim 19, wherein the receiver is arranged to receive a video sequence at least partly simultaneously captured by a camera of the second apparatus, wherein the processor is further arranged to compile the video sequences.

21. A system comprising
a first apparatus; and
a second apparatus, wherein
the second apparatus comprises
a microphone arranged to capture an audio sequence;
a transmitter; and
a processor arranged to transmit the audio sequence to the first apparatus by the transmitter, and
the first apparatus comprises
a camera arranged to capture a video sequence;
a receiver; and
a processor arranged to compile the video sequence captured by the camera with the audio sequence received from the second apparatus by the receiver and captured simultaneously as the video sequence by the second apparatus.

22. The system according to claim 21, comprising at least one network node, wherein the audio sequence transmitted from the second apparatus to the first apparatus is transmitted via the at least one network node.

23. The system according to claim 21, wherein
the second apparatus further comprises a camera arranged to capture a video sequence,
the processor of the second apparatus is further arranged to transmit the video sequence to the first apparatus by the transmitter,
the receiver of the first apparatus is arranged to receive the video sequence at least partly simultaneously captured by the camera of the second apparatus, and
the processor of the first apparatus is further arranged to compile the video sequences.

24. A computer readable medium comprising program code comprising instructions which when executed by a processor is arranged to cause the processor to perform
capturing a video sequence by a first apparatus;
receiving by the first apparatus a audio sequence from a second apparatus captured simultaneously by the second apparatus; and
compiling the video sequence and the received audio sequence.

25. The computer readable medium according to claim 24, wherein the program code further comprises instructions which when executed by a processor is arranged to cause the processor to perform
receiving by the first apparatus a third audio sequence from a third apparatus captured simultaneously by the third apparatus; and
compiling also the third audio sequence with the video sequence.

26. The computer readable medium according to claim 25, wherein the program code instructions for compiling is further arranged to cause the processor to perform mixing the audio sequences such that each audio sequence is given a mutually relative signal level in an aggregate audio sequence.

27. The computer readable medium according to claim 24, wherein the program code further comprises instructions which when executed by a processor is arranged to cause the processor to perform
capturing by the first apparatus simultaneously a first audio; and
compiling also the first audio sequence with the video sequence.

28. The computer readable medium according to claim 27, wherein the program code instructions for compiling is further arranged to cause the processor to perform mixing the audio sequences such that each audio sequence is given a mutually relative signal level in an aggregate audio sequence.

29. The computer readable medium according to claim 24, wherein the program code further comprises instructions which when executed by a processor is arranged to cause the processor to perform
sending a request from the first apparatus to the second apparatus to capture audio sequence; and
establishing an audio channel between the second apparatus and the first apparatus.

30. The computer readable medium according to claim 24, wherein the program code further comprises instructions which when executed by a processor is arranged to cause the processor to perform
receiving by the first apparatus a video sequence from a second apparatus captured at least partly simultaneously by the second apparatus; and
compiling the video sequences.
